(19) United States
(12) Patent Application Publication
(10) Pub. No.: US 2007/0136075 A1
(43) Pub. Date: Jun. 14, 2007

(54) Air travel system

(76) Inventors: Peter Lowes, Hants (GB); Beverley Bowles, Hants (GB)

Correspondence Address: BLANK ROME LLP, 600 NEW HAMPSHIRE AVENUE, N.W., WASHINGTON, DC, 20037, US

(21) Appl. No.: 10/568,958

(22) PCT Filed: Aug. 20, 2004
(86) PCT No.: PCT/GB04/03589

§ 371 Date: Aug. 14, 2006

(30) Foreign Application Priority Data
Aug. 22, 2003 (GB) 0319777.9

(51) Int. Cl. G06Q 99/00; G06Q 10/00

(52) U.S. Cl. 705/1; 705/5

(57) ABSTRACT

An air travel system in which pre-flight check-in of passengers and luggage items are conducted at passenger confirmed addresses remote from the airport of departure. All relevant luggage items are collected during the course of the pre-flight check-in and transported in secure vehicles to the airport of departure for security checks to be made. Each passenger for whom luggage items are collected receives a preliminary boarding pass including inter alia flight details, the preliminary boarding pass being exchanged with a confirmed boarding pass airside of the airport of departure.

This invention relates to an improved air travel system.

The air travel business has for a number of years been seeking to improve passenger safety at airports and during flights and to provide enhanced services particularly in the area of speedier and less stressful check-in procedures at airports.

To enhance safety, there have been a number of proposals which seek to ensure that all luggage is thoroughly checked before being loaded into an aircraft hold. Typical of these are the luggage handling proposals disclosed in U.S. Patent Applications 2002/0176531, 2002/0176532 and 2002/0186862. Each of these documents describes a system for screening passenger luggage or packages. Screening of luggage is an important procedure to minimise the risk of contraband or explosive devices being unknowingly carried by aircraft. However, luggage screening at airports immediately prior to flights inevitably creates delays to passengers seeking to move to exit gates. Similar delays occur at check-in desks where items of luggage need to be recorded, sorted and weighed with consequent long passenger queues at busy times. Also, the mere presence of a multiplicity of cases and other items of luggage being transported by hand and on trolleys by passengers before check-in can cause overcrowding with much consequent frustration to the travelling public.

On a very small scale a number of airlines operate a luggage collection system for return journey passengers from selected hotels, particularly in holiday resorts. These offer the advantages to passengers of completing an initial check-in procedure remote from the respective airport and having items of luggage delivered direct to the airport by a carrier nominated by the airline. Such a system operates only for return flights and is only operated on a very select and rare basis.

The present invention sets out to provide an improved air travel system which overcomes, or at least alleviates, many of the problems discussed above.

In one aspect, the invention provides an air travel system in which pre-flight check-in of passengers and luggage items are conducted at passenger confirmed addresses remote from the airport of departure, all relevant luggage items being collected during the course of pre-flight check-in and transported in secure vehicles to the airport of departure for security checks to be made, each passenger for whom luggage items are collected receiving a preliminary boarding pass including inter alia flight details, the preliminary boarding pass being exchanged with a confirmed boarding pass airside of the airport of departure.

In another aspect, the invention provides an air travel system in which a representative of the system operator meets with flight passengers at locations remote from the airport of departure to complete inter alia identity and security checks and to collect all items of luggage other than hand luggage for secure transportation by the system operator to the airport of departure, each item of luggage being tagged to show inter alia the identity of the passenger and the passenger being provided with a preliminary boarding pass which includes inter alia personal details of the passenger and which is exchanged airside at the airport of departure with a confirmed boarding pass.

In further aspect, the invention provides an air travel system having the following sequential steps:
(i) meeting with a passenger holding a flight reservation and ticket confirmation prior to a flight at a confirmed address of the passenger remote from the airport to
   (a) attend to pre-flight procedures;
   (b) confirm the identity of the passenger by reference to photo ID evidence;
   (c) pursue all required document and security profiling procedures;
   (d) collect all items of luggage (other than hand luggage) from the passenger;
   (e) issue a preliminary boarding pass;
   (f) provide the passenger with a receipt for items of luggage collected; and
(ii) transporting the luggage in a secure manner to the airport of departure for further checking prior to loading onto the aircraft on which the passenger is travelling.

By “photo ID” is meant an official document which includes a photograph of the passenger. Typically, this will comprise a passport or driving licence.

A passenger's items of luggage may be collected from the airport of destination by an operative and taken to an agreed address for checking and hand-over to the passenger.

The invention will now be described, by way of example only, with reference to the accompanying drawings, in which:

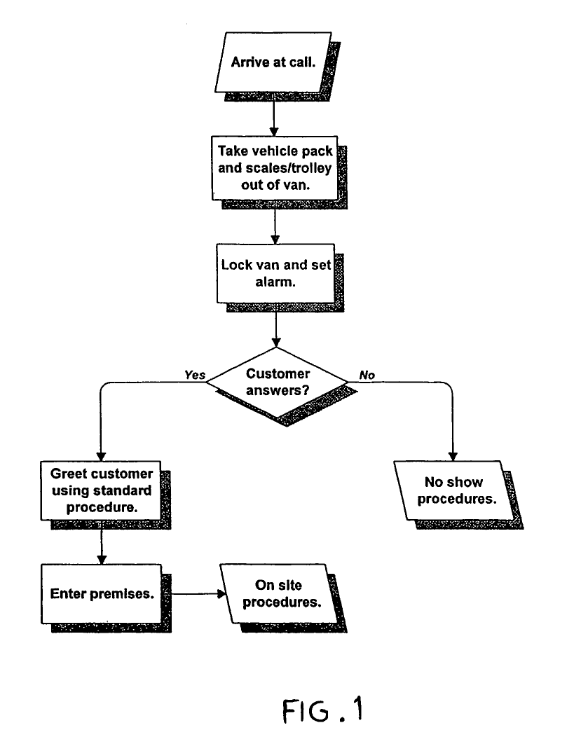

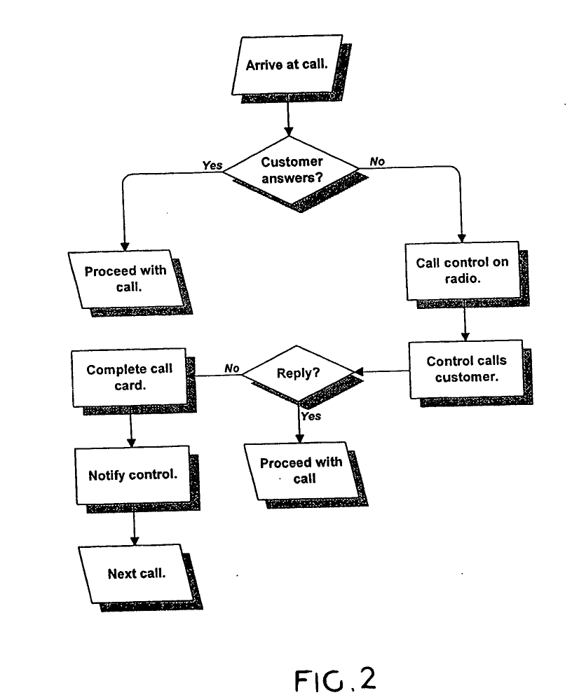

FIGS. 1 and 2 are flow charts identifying procedures adopted for a system in accordance with the invention following arrival at a confirmed address of a passenger;

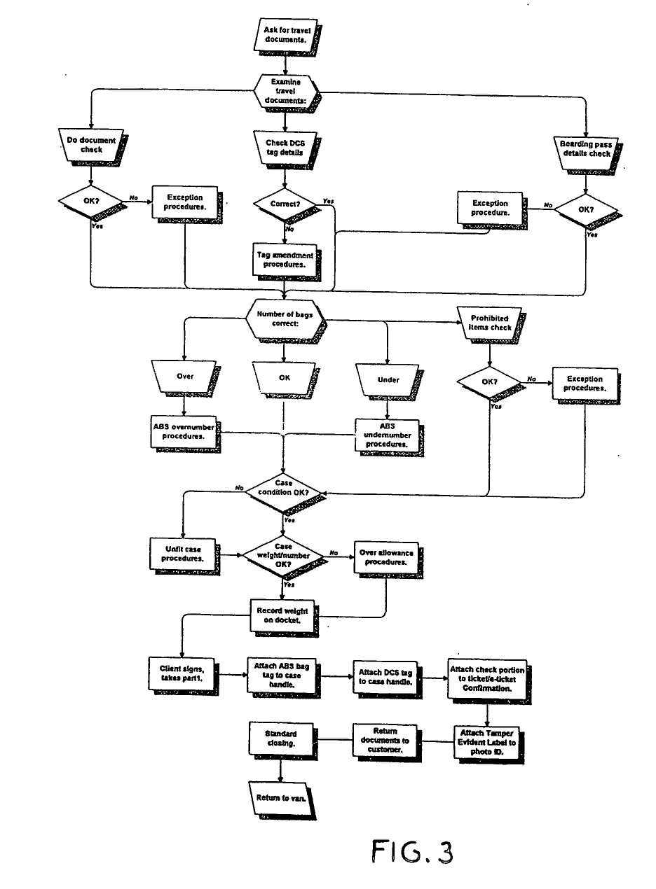

FIG. 3 is a flow chart identifying procedures adopted for a system in accordance with the invention during a pre-flight meeting with a passenger;

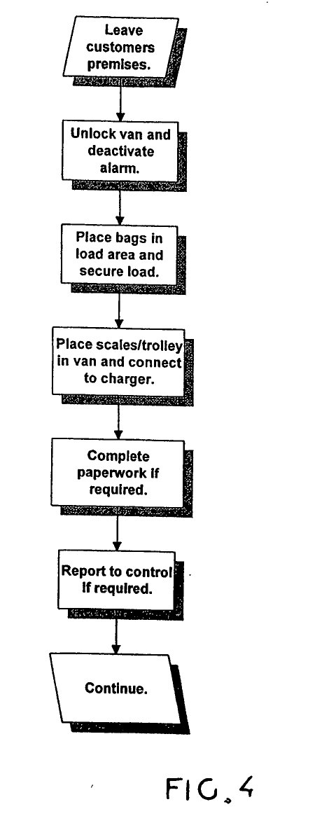

FIG. 4 is a flow chart showing procedures to be followed for a system in accordance with the invention following the procedures identified in FIG. 3;

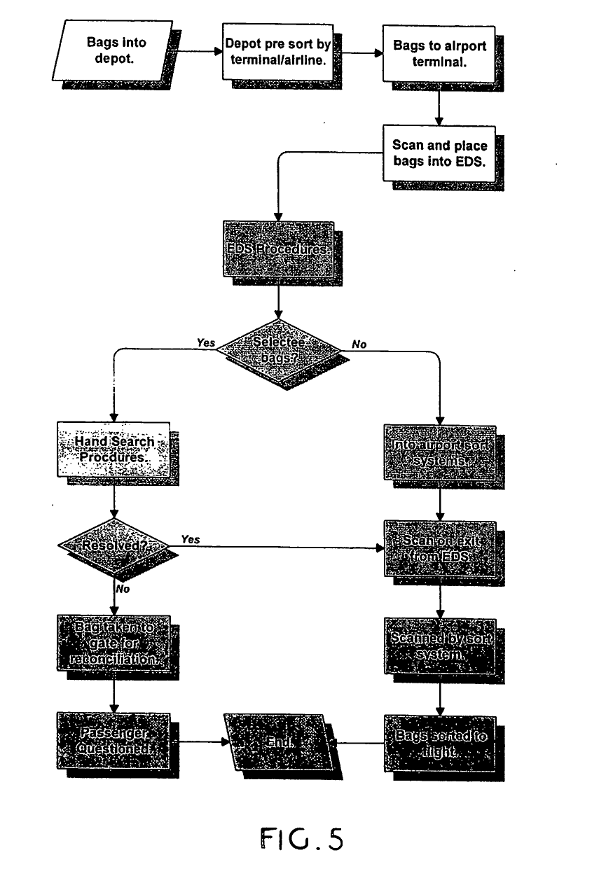

FIG. 5 is a flow chart illustrating procedures to be followed for a system in accordance with the invention after pre-flight collection of baggage items;

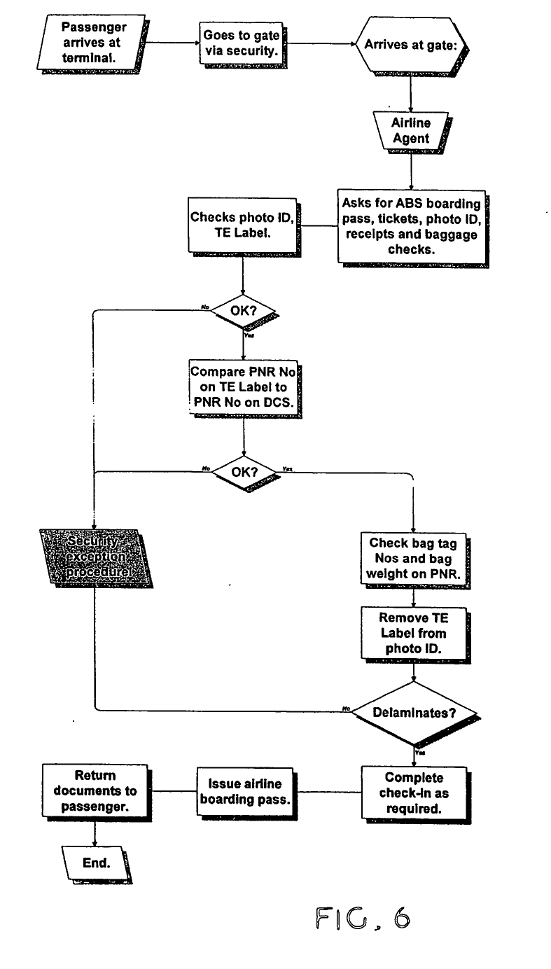

FIG. 6 is a flow chart illustrating procedures to be followed for a system in accordance with the invention by a passenger when passing through an airport of departure;

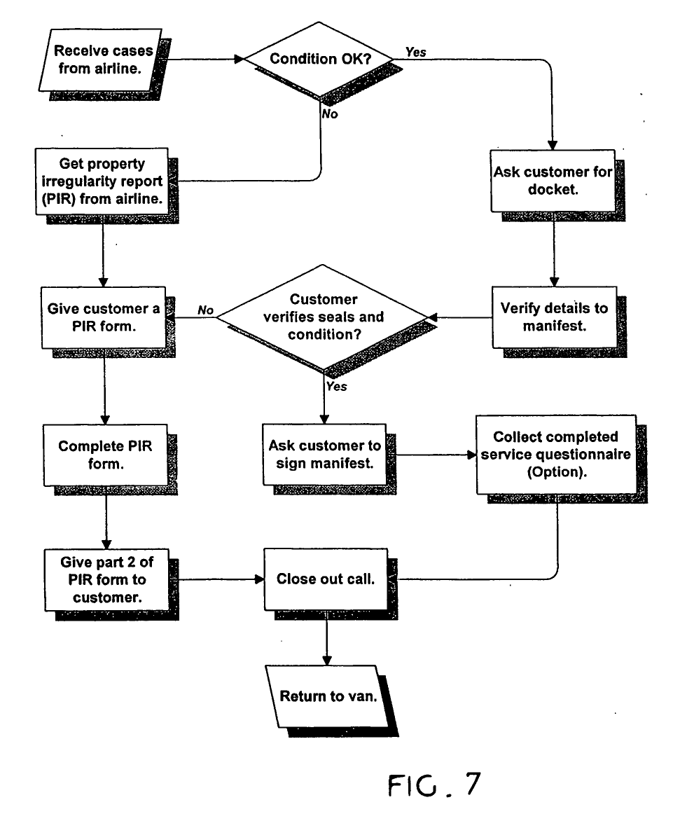

FIG. 7 is a flow chart illustrating procedures to be followed for an embodiment of a system in accordance with the invention for the handling of baggage items at an airport of destination; and

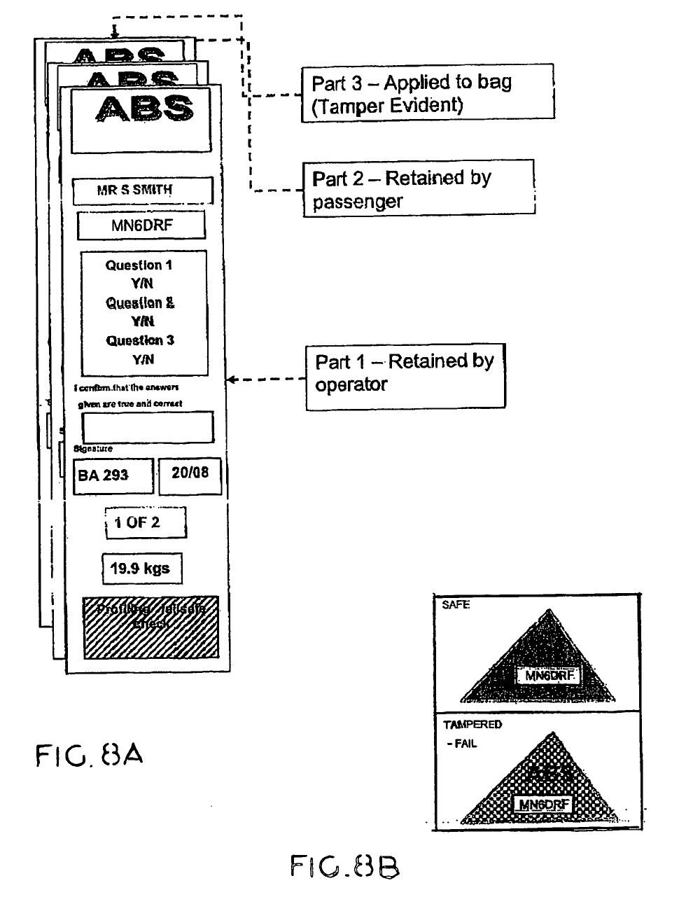

FIGS. 8A and B illustrate respectively a passenger verification tag (ABS tag) and photo ID tamper evident label in accordance with this invention.

Air travel systems in accordance with the invention include a sequence of procedures which, together, provide improved check-in facilities for passengers. Briefly, a system in accordance with the invention includes four principal stages, these comprising taking bookings from airline passengers, verifying passenger details, routing vehicles to passenger addresses to conduct pre-flight checks and to collect items of passenger luggage and tracking luggage items in transit. These procedures will be described in more detail below.

When a booking is received from an airline passenger holding a ticket confirmation issued by the respective airline, a date and time is agreed with the passenger (typically 24 hours before departure) for collection of luggage items and completion of check-in and security procedures at a confirmed address of the passenger. Typically this will be the passenger's address which appears on the ticket confirmation issued by the respective airline and may, for example, be the address of the home, hotel or office of the passenger. The passenger is advised that photographic identification (“photo ID”) will be required for check-in purposes. The form of photo ID used will be the photo ID that is used throughout the passenger's journey so, for example, on an international journey outside acceptable “domestic blocks” such as the Schengen area of the EU or the US/Canada the requirement will be for the passenger's passport.

Before collection of luggage items the passenger is contacted (typically the day before) to confirm collection details and seat selection. A preliminary boarding pass is prepared at this time.

Collection of luggage items and completion of check-in and security procedures is carried out by a trained operative using a vehicle having a secure luggage loading bay. The operative may also have access to electronic communication with other operatives at a control centre (the “Control Centre”). Prior to arrival, checks may be carried out to confirm that the address given corresponds with a known address of the passenger. On arrival at the address, the operative may notify the Control Centre and the relevant vehicle status may be recorded by the Control Centre as “pick up”.

The various steps to be followed on arrival are set out in FIG. 1. All documents necessary for the check-in procedure are removed from the vehicle together with luggage weighing and handling equipment. The vehicle is then locked and the vehicle alarm set. The documents are conveniently retained in a wallet and typically include the pre-printed preliminary boarding pass, required number of luggage tags and dockets.

Two species of tags are employed, one being an IATA standard interline departure control system (DCS) tag and the other being a passenger verification tag issued by the system operator. The latter tag is three-part prefaced by the letters “ABS” in some of the drawings and is referred to as such below. The ABS tag is illustrated in FIG. 8A and will be described in more detail below.

In the event that the passenger is not at the address, the operative returns to his vehicle and notifies the Control Centre (if appropriate) who will initiate a customer “no-show” procedure. The procedures to be followed in this situation are set out in FIG. 2.

On gaining entry to the passenger's premises the procedures set out in FIG. 3 are followed. The check-in procedures conducted by the operative generally replicates those which are presently conducted at the airport of departure and are designed to ensure that the passenger has the correct travel documentation, i.e. that the passport or other photo ID is valid and that the ticket details are correct. As will be seen from FIG. 3, to begin the procedure the operative requests sight of the passenger's passport or alternative photo ID and the ticket/e-ticket confirmation received from the airline to confirm the identity of the passenger and to check that all details on the travel documents match the details on the pre-printed preliminary boarding pass to be issued. This preliminary boarding pass is to be exchanged with a confirmed boarding pass when the passenger is airside at the airport of departure.

If the details shown on the preliminary boarding pass do not correspond with the passenger's requests, the operative advises the passenger to contact the airline.

As for conventional check-in procedures, the operative will ask specifically about prohibited items typically using the IATA standard checklist. These checks are designed to ensure that the passenger's baggage is not carrying any item which is prohibited by law or by international industry standards. The operative may also perform further document checks if required to do so by the regulatory agencies.

If for any reason a passenger fails to answer the required security profiling satisfactorily, the pick-up may be terminated. If security profiling is satisfactory, the passenger's luggage is weighed. If any item is overweight, and the passenger refuses to reduce the weight to allowable levels, then the passenger will be referred to the regular airline check-in and the pick-up aborted.

An IATA standard DCS tag is attached to the bag and the baggage check portion is attached to the customer's flight ticket-e-ticket confirmation. The customer is asked (where required) to sign the declaration on the three-part ABS bag tag. The operator retains part 1, the passenger retains as his receipt part 2 and part 3, which is tamper evident, is attached to the bag in such a way as to seal the bag. As will be seen from FIG. 8A, the ABS tag typically includes the passenger' name, the airline, security question requirements, the passenger's signature, flight details and date, number of luggage items and profiling failsafe check. A tamper evident label as shown in FIG. 8B matching the receipt given to the passenger is attached to the passenger's passport or other photo ID. This label has a “tamper evident” status, that is to say, any attempt to remove or change the label will be immediately recognised when the label is inspected. Finally, a preliminary boarding pass as described above is given to the passenger.

On returning to the vehicle, the operative conducts the procedures shown in FIG. 4. These procedures are self-evident from FIG. 4.

Following pre-flight collection of all items of luggage (apart from hand luggage) from a number of passengers, the operative returns to a secure depot normally in or alongside the airport of departure for sorting and consolidation of the luggage items. The tags of each luggage item are checked and the luggage weight verified against the weight recorded during the initial check-in procedures. Each item of luggage is unloaded from the secure loading bay of the vehicle and is scanned with a bar code scanner. The system responds by indicating to which of several destinations each luggage item is to be sorted.

This cycle is illustrated in FIG. 5 and is repeated until all items of luggage have been loaded onto baggage carts and these have been placed in the load area to await delivery.

Each luggage item is then transferred to its airport of departure for EDS screening by authorised operatives. Systems in accordance with the invention provide for a depot to be equipped with EDS equipment and for depot screening by authorised personnel in the event that volumes dictate that this is more practical than on airport screening.

The steps taken when luggage items are transferred to the airport of departure are also shown in FIG. 5. On handover by the system operator, all luggage items are subjected to all appropriate checks including scanning and screening before being sorted for eventual loading onto the aircraft that the passenger is travelling on. Selected or suspect items of luggage may be taken to a departure gate to await the respective passenger and then subjected to hand searching prior to loading onto the flight.

By virtue of the procedures discussed above, a passenger arriving at the airport of departure goes directly to the security checkpoint with his preliminary boarding pass and proceeds airside.

At the departure gate (or other approved airside location) the passenger hands over his/her preliminary boarding pass and baggage receipts, passport or photo ID and tickets. The gate check-in procedure is illustrated in FIG. 6. Essentially, the airline agent at the departure gate checks the photo ID of the passenger, that the reference matches the passenger name on the receipts and that the condition of the tamper evident label is as it should be.

If the integrity of the tamper evident label has been compromised, the passenger is given “selectee” status and is reunited with his/her bag(s) for security inspection. If the passenger's bags were “selected” as part of the formal screening process, the PNR will have been flagged and the bags held at the gate to be reunited with the passenger for inspection. The confirmed boarding pass is not issued until these inspections have been satisfactorily concluded.

If the tamper evident label has not been compromised and the bags have not been “selected”, the preliminary boarding pass is exchanged for a standard airline boarding pass. The passenger then boards as normal.

As indicated previously, the travel system may also provide for delivery of luggage items to passengers on arrival at the airport of destination. The steps undertaken are shown in FIG. 7. As will be seen from FIG. 7, the condition of luggage received by the system operator from the airline is checked and those items found to be in a satisfactory condition are loaded onto a secure vehicle for return to the respective passengers at agreed addresses remote from the airport. On arrival at the agreed delivery location the passenger shows to the operative the or each luggage receipt issued when the luggage was collected pre-flight. The relevant luggage is then removed from the vehicle and luggage items are released to the passenger.

In the event that the passenger is not at the agreed delivery location, the operative returns to the vehicle and proceeds to the next call.

Air travel systems in accordance with the invention provide a number of advantages, these including:

bag tags are attached to luggage items at locations remote from the airport and passengers are provided with receipts for these items;

required security questions are asked and a signed declaration is obtained from each passenger during the initial check-in remote from the airport;

items of luggage are recorded and checked for condition and weight during the initial off-airport check-in;

a passenger is issued with a preliminary boarding pass on conclusion of this off-airport check-in;

all relevant data is transferred to the airline departure control system by way of continuous real time updates before and up to flight departure;

luggage is moved in a secure way to the airport;

all baggage screening can be performed off-peak without inconveniencing passengers;

exception handling is permitted within a non critical time window;

a passenger is reconciled and matched with his/her luggage; airport peaks are flattened substantially and queues are consequently reduced;

passengers are relieved of the need to carry luggage items to the airport of departure and, probably, to take these luggage items to an agreed address at the airport of destination; and

airport crowding at airports is significantly reduced at peak periods.

It will be appreciated that the foregoing is merely exemplary of air travel systems in accordance with the invention and that modifications can readily be made thereto without departing from the true scope of the invention as set out in the appended claims.

1. An air travel system characterised by the following steps:
(i) meeting with a passenger holding a flight reservation and ticket confirmation prior to a flight at a confirmed address of the passenger remote from the airport to attend to pre-flight procedures;
(ii) confirming at that meeting the identity of the passenger by reference to photographic identification (photo ID) evidence;
(iii) confirming details of the passenger's ticket confirmation;
(iv) pursuing all required document and security profiling procedures;
(v) collecting all items of luggage (other than hand luggage) from the passenger;
(vi) issuing a preliminary boarding pass;
(vii) providing the passenger with a receipt for items of luggage collected; and
(viii) transporting the luggage in a secure manner to the airport of departure for further checking prior to loading onto the aircraft on which the passenger is travelling.

2. A system as claimed in claim 1 wherein the photo ID evidence comprises an official document which includes a photograph of the passenger.

3. A system as claimed in claim 2 wherein the photo ID comprises a passport or driving licence.

4. A system as claimed in claim 1 wherein prior to the meeting with a passenger, a check is conducted to establish that the address given by the passenger is a known address of the passenger.

5. A system as claimed in claim 1 wherein information carrying tags are secured to the collected items of luggage, these tags comprising a standard interline departure control system tag and a passenger verification tag.

6. A system as claimed in claim 5 wherein the passenger verification tag includes the passenger's name, the passenger's signature and details of the flight on which the passenger is travelling.

7. A system as claimed in claim 6 wherein the passenger verification tag also includes a tamper evident label matching the luggage items receipt given to the passenger.

8. An air travel system in which pre-flight check-in of passengers and luggage items are conducted at passenger confirmed addresses remote from the airport of departure, all relevant luggage items being collected during the course of pre-flight check-in and transported in secure vehicles to the airport of departure for security checks to be made, each passenger for whom luggage items are collected receiving a preliminary boarding pass including inter alia flight details, the preliminary boarding pass being exchanged with a confirmed boarding pass airside of the airport of departure.

9. An air travel system in which a representative of the system operator meets with flight passengers at locations remote from the airport of departure to complete inter alia identity and security checks and to collect all items of luggage other than hand luggage for secure transportation by the system operator to the airport of departure each item of luggage being tagged to show inter alia the identity of the passenger and the passenger being provided with a preliminary boarding pass which includes inter alia personal details of the passenger and which is exchanged airside at the airport of departure with a confirmed boarding pass.

10. A system as claimed in claim 1 wherein a passenger's items of luggage are collected from the airport of destination by an operative and taken to an agreed address for checking and hand-over to the passenger.

11. An air travel system substantially as herein described.
